(19) United States
(12) Patent Application Publication
(10) Pub. No.: US 2002/0078020 A1
(43) Pub. Date: Jun. 20, 2002

(54) Method and system of entering search criteria using multiple entry fields per data element

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/972,739

(22) Filed: Oct. 5, 2001

Related U.S. Application Data
(60) Provisional application No. 60/238,577, filed on Oct. 6, 2000.
(60) Provisional application No. 60/238,791, filed on Oct. 6, 2000.
(60) Provisional application No. 60/238,587, filed on Oct. 6, 2000.
(60) Provisional application No. 60/238,754, filed on Oct. 6, 2000.
(60) Provisional application No. 60/237,254, filed on Oct. 2, 2000.
(60) Provisional application No. 60/237,250, filed on Oct. 2, 2000.
(60) Provisional application No. 60/237,243, filed on Oct. 2, 2000.
(60) Provisional application No. 60/237,249, filed on Oct. 2, 2000.

(51) Int. Cl. G06F 7/00

(52) U.S. Cl. 707/1

(57) ABSTRACT

A method and system whereby users can easily provide search criteria without knowing the syntax required to search a target data repository and without understanding how to construct a boolean search, and whereby novice users are made aware of search operations that will help them find their desired result. Two or more data entry fields share a fixed association with a data element, with each entry field having a fixed association with a different search operation. A computer with appropriate software translates the search input and the associated operations into the required syntax.

### COPYRIGHT NOTICE

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### FIELD OF THE INVENTION

The invention relates generally to information retrieval from data repositories, and more particularly to a method and system for providing search criteria to a search engine in a manner that provides a simpler way to achieve the desired result.

### BACKGROUND OF THE INVENTION

As a society, we are increasingly becoming both dependent on and overloaded with information, especially data that is stored in computer databases or full-text collections. As the number of these data repositories increases, the complexity of retrieving relevant information also increases. To locate relevant information, users search general collections (e.g., AltaVista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). In fact, according to recent studies from technology analysts (e.g., the Jupiter Group and Forrester Research), Internet searching is the most common online activity next to sending/receiving e-mail communications.

Data repositories may take on several forms, including relational databases, hierarchical databases, and flat-file databases, all of which support and may require searching within specific fields or columns, full-text collections which may or may not support searching within fields or delimited portions of documents that are represented as fields, and/or one or more documents. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled).

Generally, a user can search a data repository by providing search criteria to a search engine by entering or selecting, using user-input devices, text strings containing numbers, keywords and/or phrases; hereinafter called “terms.” Many search engines allow terms to be coupled with the standard boolean logic operators “AND” (to match both adjacent terms) and “OR” (to match either adjacent term), and “NOT” (to omit items which match the following term). Other search engines support different operators such as preceding a term with “+” to indicate that the term is required, or different syntax such as preceding with “−” for the boolean “NOT.”

There are two basic search interfaces in wide use today: (1) providing a single data entry field that allows the user to enter both search criteria and search operations; and (2) providing a control for the user to select an operator associated with one or more data entry fields. Each has pros and cons; discussed next.

(1) Typing search operations directly offers the most flexibility and, for those who are fluent in the required text syntax, is generally faster and more flexible than selecting search operations from controls. However, the required syntax varies from one data repository or search engine to another, and the search interface often does not specify what syntax is supported, presenting an obstacle even to those who are fluent in more than one syntax. But the major drawback is for those who are not fluent in any search syntax. As with traditional command-line interfaces, they must “remember and type” rather than the simpler “see and point.” Finally, many users are not even aware that there are operations which may help them find their desired result, so they do not even know that it's worthwhile to investigate any provided “help” and learn the required syntax.

(2) Providing controls for search operations follows the “see and point” approach. With visible options, intermediate-level users can select from operations they have seen before instead of having to recall the correct command on their own. In addition, at least some of the operations are clearly visible to those who would not otherwise be aware of the search operations. This benefit is somewhat limited in practice since drop-down menus rather than radio buttons are generally used, forcing the novice user to press and hold the mouse or pointing device in order to see every operation. Further, users who are not “technically” oriented may be intimidated by the apparent requirement that they construct an expression using the search operations—even if the default setting of the controls would suffice. As noted in the previous section, using controls is generally slower and less flexible for those who are fluent in the required text syntax. Further, in order to provide flexibility, many entry fields and controls are required for each data element, which makes this approach impractical for search forms that give access to many data elements.

U.S. Pat. No. 5,606,691, “Method of searching a database using selected criterion having implicit logical operation,” recites one solution to this problem. However, it is restricted in scope to providing the user with a method of selecting from a plurality of displayed search sub-criteria and either moving the selected sub-criterion to a different portion of the display, or automatically selecting associated sub-criteria.

One job search site, ComputerJobs, includes 3 numbered text boxes collectively labelled “Exclude filters” plus the text “A quick way to screen out jobs. If you type in a word here, jobs with that word will not be included in the search.” While this approach does offer a minor improvement, it suffers from a number of limitations. The text implies that only individual words are supported, however, it's often useful to exclude based on a whole phrase. With exactly three boxes, the configuration implies that only three Exclude criteria are allowed. However, additional criteria can be useful, especially in the case of a repeat visitor. For example, a job seeker may build up over time a list of well over three companies whose openings otherwise match their search criteria but for whom they are not interested in working. The most severe limitation is that the Exclude criteria cannot be associated with a specific database field or delimited portion of a document; hence it will often exclude far more than is intended. One final limitation: this feature is offered only on stored job searches, not in the “job matching” section, the standard keyword search, or the “power search.”

Thus, there is a need to provide a simpler method of entering search criteria, especially a single method that satisfies the needs of users with widely varying levels of expertise in searching data repositories.

### SUMMARY OF THE INVENTION

In the present invention, two or more data entry fields share a fixed association with a data element, with each entry field having a fixed association with a different search operation. A computer with appropriate software translates the search input and the associated operations into the target syntax.

The present invention overcomes the prior art limitations by fixing the association of an operation with a data entry field, thus saving advanced users the time required to determine which syntax is supported, saving advanced and intermediate users from the effort of selecting an operation, saving intermediate users from having to “remember and type,” saving novice users from the intimidation associated with constructing a search expression, and saving novice users the time required to explore controls to discover hidden search operations. To satisfy the needs of advanced users, one or more of the data entry fields can also support some or all of the standard textual search operations.

It is an object of the invention to provide a method and system whereby users can easily provide search criteria without knowing the syntax required to search the target data repository. It is a further object of the invention to provide a method and system whereby users can easily provide search criteria without understanding how to construct a boolean search. It is a further object of the invention to provide a method and system whereby novice users are made aware of search operations that will help them find their desired result.

Other objects and advantages of the invention will, in part, be obvious, and, in part, be shown from the following description.

### BRIEF DESCRIPTION OF THE DRAWINGS

FIG. 1 is a schematic representation depicting one illustrative embodiment of the invention, wherein the invention is coupled to a network;

FIG. 2 depicts one illustrative embodiment of the invention's user interface as an HTML fill-in form;

FIG. 3 depicts illustrative translations showing one input and the output in various syntaxes;

FIG. 4 is a flow chart depicting the steps for one illustrative method of one illustrative embodiment of the invention;

FIG. 5 is a schematic representation depicting one illustrative embodiment of the invention, wherein the invention interacts with a single electronic device;

FIG. 6 depicts another illustrative embodiment of the invention's user interface as an HTML fill-in form.

### LIST OF REFERENCE NUMERALS

10 system with network

12A-12C IADs

14A-14C Web browsers

16 network

18 HTTP Web server

19 translator input port

20 translator

21 translator output port

22 search engine

24 data repository

26 formatting engine

28 server computer

50 system with single electronic device

### DESCRIPTION OF THE ILLUSTRATIVE EMBODIMENTS

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, hand-held computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks; “processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

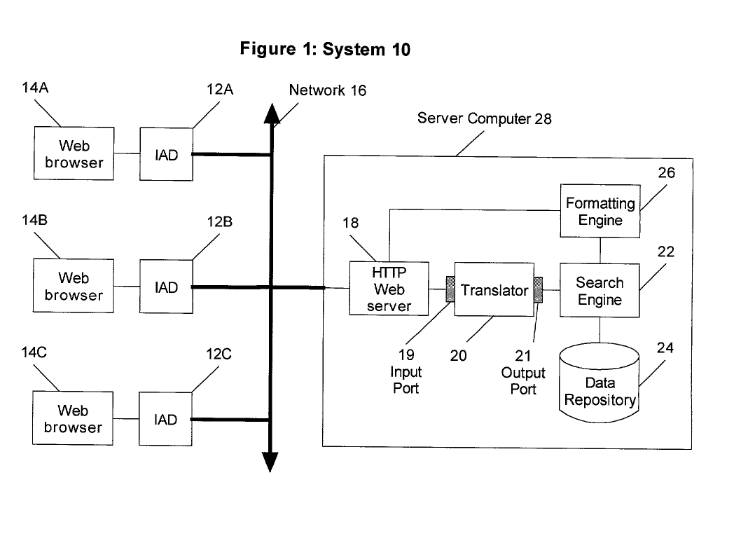

FIG. 1 depicts an illustrative embodiment of one system 10 according to the invention which enables a user to easily provide search criteria over a network without knowing the syntax required to search the target data repository and without understanding how to construct a boolean search, and which locates and presents data that meets the search criteria. The system comprises a plurality of IADs 12A-12C, each integrated with or coupled to Web browser 14A-14C and coupled to a network 16, which is in turn coupled to an HTTP Web server 18, which is coupled to a translator 20 via translator input port 19 according to the current invention. The translator 20 is coupled to a search engine 22 via translator output port 21 which is coupled both to a data repository 24 and a formatting engine 26. The formatting engine 26 is coupled to the HTTP Web server 18 in order to return matching data to the IADs 12A-12C to display for the users on client processes such as Web browsers 14A-14C.

For this illustrative embodiment, the HTTP Web server 18, translator 20 with ports 19 and 21, search engine 22, data repository 24 and formatting engine 26 reside on a single server computer 28 which may be a Macintosh G3 running MacOS 8.5. For this illustrative embodiment, the HTTP Web server 18 is built into the commercial Content Management System/Application Server known as UserLand Frontier, translator 20 is coded in the UserTalk language embedded in UserLand Frontier, search engine 22 and data repository 24 are commercial database management software known as FileMaker Pro, and formatting engine 26 is coded in the UserTalk language embedded in UserLand Frontier.

It will be readily apparent to those skilled in the art that the server computer 28 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel-compatible PC or server running Linux or FreeBSD or other UNIX OS, or a server computer from Sun, HP, IBM or other company, running Solaris, HP-UX, AIX or other variation of UNIX or other OS.

It will be readily apparent to those skilled in the art that the functions performed in this embodiment with a single server computer 28 could be divided among a plurality of server computers from the same or different manufacturers, with each computer running the same or different operating systems.

It will be readily apparent to those skilled in the art that the HTTP Web server 18 could be WebStar, WebTen, Microsoft IIS, Apache or other commercial or open source Web server, and that translator 20 and/or formatting engine 26 could be coded in any suitable scripting or programming language such as Perl, JavaScript, Java, VBScript, Visual BASIC, C++, etc. or any suitable content management system or application server such as Vignette StoryServer, Allaire ColdFusion, SilverStream, etc. and interact with HTTP Web server 18 via CGI, plug-in, servlets, Enterprise Java Beans, etc., and that translator 20 and formatting engine 26 need not be coded in the same language or developed in the same content management system or application server.

It will be readily apparent to those skilled in the art that search engine 22 and data repository 24 could be any suitable database management system such as Oracle, Informix, Sybase, SQL Server, Access, mySQL, PostgreSQL, etc. or full-text search engine and associated collection or other index mechanism such as those provided by Verity, UltraSeek, Thunderstone, etc., and/or other software capable of storing and searching data.

It will be readily apparent to those skilled in the art that the functions performed in this embodiment by a single search engine 22 could be performed by several search engines, linked to the same or to several data repositories.

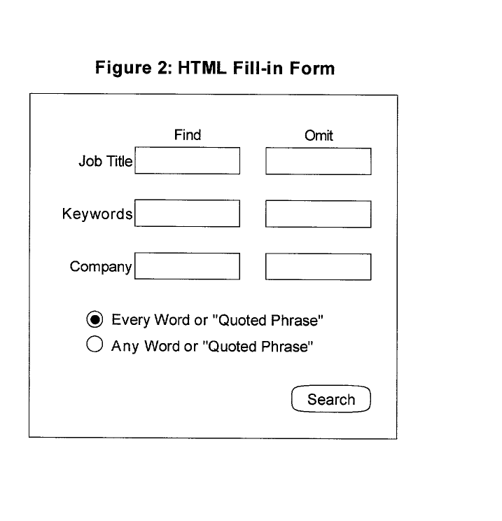

FIG. 2 depicts one illustrative embodiment of the interface presented by a Web browser 14 as an HTML fill-in form on the VDU of an IAD 12, with the search engine 22 configured to search a data repository 24 ofjob openings. In this illustrative embodiment, the interface is comprised of one column of text entry fields labeled “Find,” a second column of text entry fields labelled “Omit,” a first row labelled “Job Title” with one text entry field in the “Find” column and one in the “Omit” column, a second row labelled “Keywords” with one text entry field in the “Find” column and one in the “Omit” column, and a third row labelled “Company” with one text entry field in the “Find” column and one in the “Omit” column.

In this embodiment, the “Keywords” field represents all the fields that comprise the job opening except for those fields that appear on the search form, here “Job Title” and “Company.” In this embodiment, the interface is further comprised of two radio button options labelled as follows (including the quotation marks), with the first radio button selected by default:

Every Word or “Quoted Phrase”

Any Word or “Quoted Phrase”

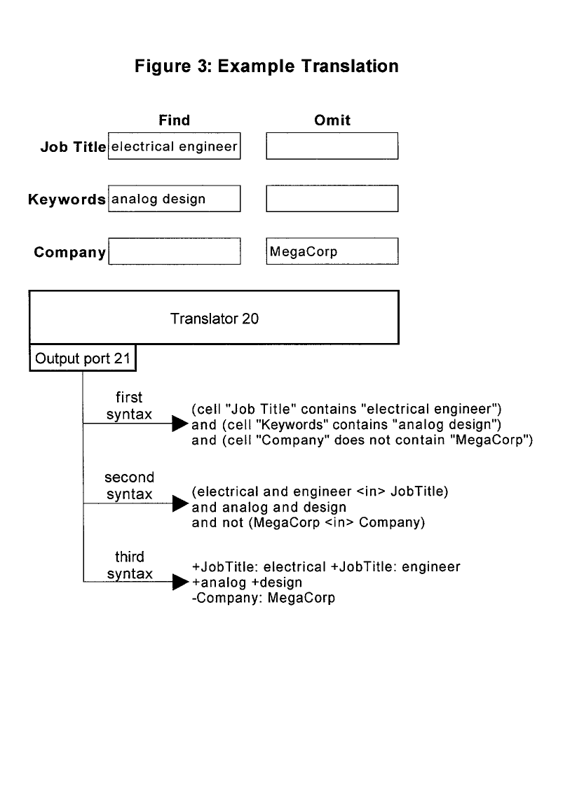

In this embodiment, the interface is further comprised of a button labelled “Search.” With this embodiment of the invention, users can easily provide search criteria without knowing the syntax required to search the target data repository and without understanding how to construct a boolean search. For example, if a user is seeking employment as an electrical engineer, she may enter text such as “electrical engineer,” into the Find field adjacent to the “Job Title” label. Further, if the user specializes in a certain branch of electrical engineering, she may enter text such as “analog design” in the Find field adjacent to the “Keywords” label. Further, if the user is currently employed by MegaCorp, and she does not want to locate any employment opportunities at MegaCorp, then she may enter the text “MegaCorp” into the Omit field in the same row as the “Company” label. The translator will convert this information into search criteria that directs a search engine to locate employment opportunities for electrical engineers to work on analog design, but not any employment opportunities at MegaCorp. FIG. 3 shows this illustrative example with the translated output in various syntaxes. For use with a single search engine, only one syntax is required.

It will be readily apparent to those skilled in the art that the interface could be modified to apply to other domains, e.g. with data elements such as “Skills” to search resumes of job seekers, or “Amenities” to search apartments for rent, or “Location” to search houses for sale, etc.

It will be readily apparent to those skilled in the art that the interface could be presented in many fashions, e.g. as an XML fill-in form, a PDF fill-in form, a form implemented in a Java applet or Active X control, a form implemented using client-server software, and otherwise.

It will be readily apparent to those skilled in the art that one or more of the text entry fields could be replaced with single-valued enumerated input controls such as radio buttons, drop-down / pop-up menus, or scrollable lists and/or with multi-valued enumerated input controls such as checkboxes or scrollable lists.

It will be readily apparent to those skilled in the art that the “Keywords” field could represent either a narrower or broader portion of a job listing, ranging from a single explicit field of keywords to the entire job listing.

It will be readily apparent to those skilled in the art that the pair of radio button options could be omitted and one or the other behavior chosen as the default, or could be presented using different controls such as a single checkbox representing one behavior in the “on” state and the other in the “off” state, or as drop-down/pop-up menus, or a scrollable list, or otherwise. It will be further apparent that the radio button options, however displayed, could be replicated and associated with specific fields in order to provide different options for different fields.

It will be readily apparent to those skilled in the art that the interface could include more or fewer fields (rows in this embodiment), that some fields may not have both Find and Omit search entry boxes, that the organization into rows vs. columns could be swapped such that “Find” and “Omit” are row labels and the field labels are column labels, and many other variations.

Operation

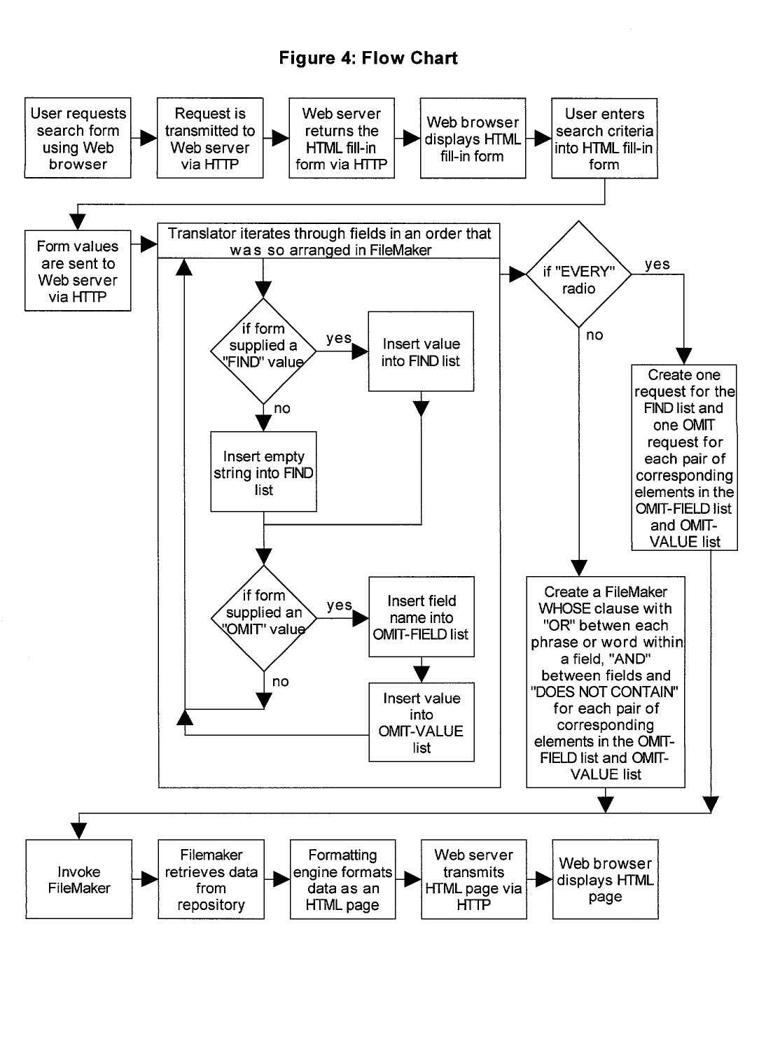

FIG. 4 is a flow chart that depicts the operation of one illustrative embodiment. The user controls a UD to provide input to a Web browser 14 running on the IAD 12 to request the search form. The Web browser 14 sends the request over the network 16 via the HTTP protocol to the HTTP Web server 18 running on the server computer 28, which returns the search form as an HTML page over the network 16 via the HTTP protocol back to the user's Web browser 14 which displays it on the VDU of IAD 12.

The user then controls one or more UDs to interact with the Web browser 14 to enter search criteria into the search entry fields, and then to click the Search button. The Web browser 14 sends the form values over the network via the HTTP protocol to the HTTP Web server 18, which forwards the form values to the translator 20.

The translator 20 in this illustrative embodiment assembles a series of Query By Example requests for FileMaker, as follows. The translator 20 first checks the form values to see which radio button was selected. In the case of Every Word or “Quoted Phrase,” no extra effort is required since this selection corresponds to FileMaker's default search behavior. This case will be described first. A first request is assembled by iterating through the fields in a stored order that corresponds to an order that was so arranged in FileMaker, and inserting the value of the user's search criteria for that field, if any, or an empty value. When checking each field in the stored order, the translator 20 also assembles a pair of omit lists, one list for the field name, one list for the corresponding value, populates these lists for any field which has an omit value, and creates an additional request in FileMaker for each such field. In the case of a radio button selection of Any Word or “Quoted Phrase,” the translator 20 splits the contents of each search value into constituent phrases or words, and creates in FileMaker one request for each combination.

If translator 20 is configured to interact with an SQL search engine, then it will assemble an SQL query by converting field names to the required syntax, and by joining the constituent phrases or words of each entry field with AND in the case of a radio button selection of Every Word or “Quoted Phrase” or with OR in the case of a radio button selection of Any Word or “Quoted Phrase,” and in either case inserting NOT before each sub-expression assembled from an omit value.

If translator 20 is configured to create a boolean expression for a search engine, then it will do so by converting field names to the required syntax, and by joining the constituent phrases or words of each entry field with AND in the case of a radio button selection of Every Word or “Quoted Phrase” or with OR in the case of a radio button selection of Any Word or “Quoted Phrase,” and in either case inserting NOT before each sub-expression assembled from an omit value.

If translator 20 is configured to create an “Internet” expression for a search engine, then it will do so by converting field names to the required syntax, and by inserting “+” before each constituent phrase or word of each entry field in the case of a radio button selection of Every Word or “Quoted Phrase,” with no change required in the case of a radio button selection of Any Word or “Quoted Phrase,” and in either case inserting “−” before each constituent phrase or word of each omit entry field.

In this illustrative embodiment, the translator 20, or a separate control program, then initiates the search with the assembled requests, SQL statement or search engine expression, receives from the search engine 22 and data repository 24 specified portions of each record that matches the search criteria, and sends this data to the formatting engine 26. The formatting engine 26 formats the data as an HTML page and sends it to the HTTP Web server 18, which returns the HTML page over the network via the HTTP protocol back to the user's Web browser 14 which displays it on the VDU of IAD 12.

It will be readily apparent to those skilled in the art that the translator 20 could perform the same translation using somewhat different steps, or by varying the order of certain steps, and that the exact expression that is generated may vary somewhat (e.g. regarding the presence or absences of parentheses, or otherwise) without changing the meaning of the expression. It will also be apparent that the translator 20 could be configured to translate to other formats required by other search engines, or otherwise to direct other search engines or programs to match the specified search criteria.

Alternative Embodiments

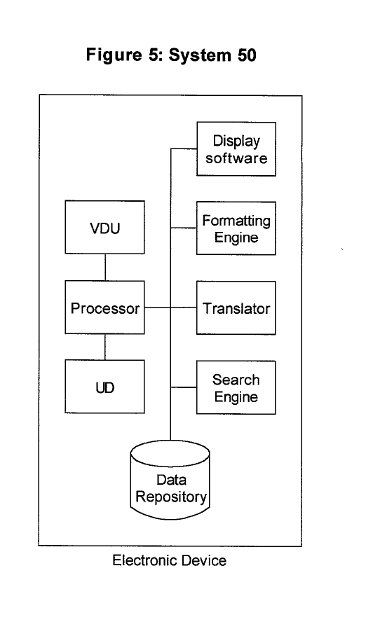

FIG. 5 depicts another illustrative embodiment of a system 50 according to the invention which enables a user to easily provide search criteria without knowing the syntax required to search the target data repository and without understanding how to construct a boolean search, and which locates and presents data that meets the search criteria. The system comprises a single electronic device with at least one processor, at least one UD, at least one VDU, with the system 50 running software configured as one or more components to display the search form, accept user input, translate the input to a predetermined syntax, perform a search on a local or embedded data repository, format the result and present the result to the user on the VDU.

It will be readily apparent to those skilled in the art that one or more of the depicted individual components could be moved to a different device, situated locally or remotely, to, for example, support a remote data repository or have certain functions performed remotely.

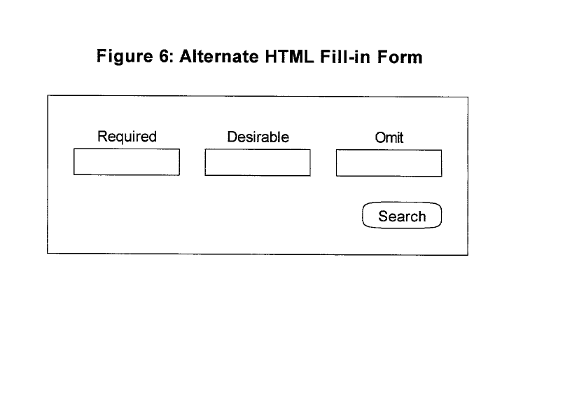

FIG. 6 depicts another illustrative embodiment of the interface of the invention, which could be used in conjunction with system 10 or system 50 or otherwise. In this embodiment, the interface is comprised of one text entry field labeled “Required,” a second text entry field labelled “Desirable,” and a third text entry field labelled “Omit,,” and a button labelled “Search.” This embodiment is particularly appropriate for a general Internet or Intranet search engine which may index documents and other data that may not be structured into fields, and which engine has built-in support for ranking matches according to the Desirable search criteria in addition to locating matches the meet the Required search criteria and do not meet the Omit search criteria. This embodiment can also be used with a traditional fielded search engine by assembling the required syntax and post-processing the result to rank according to the Desirable search criteria.

It will be readily apparent to those skilled in the art that the interface could include additional text entry fields that are associated with specific data fields, either instead of or in addition to a general field that may be associated with an entire document or data object, and that the visual layout could be changed to put the labels in a different position with respect to the fields, or to align the fields as a column, and many other variations.

As previously indicated, those skilled in the art will know or be able to ascertain using no more than routine experimentation, many equivalents to the illustrative embodiments and practices described herein. It will also be understood that the methods and systems described herein provide advantages over the prior art including saving advanced users the time required to determine which syntax is supported, saving advanced and intermediate users from the effort of selecting an operation, saving intermediate users from having to “remember and type,” saving novice users from the intimidation associated with constructing a search expression, and saving novice users the time required to explore controls to discover hidden search operations. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. A Search Entry System (SES) for aiding a user in employing an Information Location Mechanism (ILM) to locate relevant information, the SES being configured to display entry fields on a Visual Display Unit (VDU) via a client process, the SES being responsive to a User-input Device (UD), the SES comprising:
a first entry field configured to receive a first search input from the UD, the first entry field having a fixed association with a data element and with a first search operation;
a second entry field configured to receive a second search input from the UD, the second entry field having a fixed association with the data element and with a second search operation;
a translator configured to translate the first search input, the second search input, the data element's identifier, the first search operation, and the second search operation into a syntax that is valid for the ILM; and
an output port configured to send the translated search criteria to the ILM and/or to the mechanism that invoked the SES;
whereby users can easily provide search criteria without knowing the syntax of the ILM or understanding how to construct a boolean search and whereby novice users are made aware of search operations that will help them find their desired result.

2. The SES recited in claim 1 wherein at least one of the entry fields is comprised of a text box configured to receive a text input.

3. The SES recited in claim 1 wherein at least one of the entry fields is comprised of an enumerated input means including a pop-up menu, a drop-down menu, a scrollable list, a set of checkboxes or a radio button group.

4. The SES recited in claim 1, further comprising a label for at least one of the entry fields for identifying to the user the operation associated with the entry field.

5. The SES recited in claim 1, further comprising a label for at least one of the entry fields for identifying to the user the data element associated with both entry fields.

6. The SES recited in claim 1, further comprising a command line prompt.

7. The SES recited in claim 1 wherein the ILM is comprised of a database, a database management system, a search engine supporting full-text search, a search engine supporting fielded search, a search engine supporting regular expressions and/or other patterns, and/or an iterative search engine.

8. The SES recited in claim 1 wherein each data element is comprised of a database field, tagged data such as HTML, XML, or SGML, meta data, and/or a document.

9. The SES recited in claim 1 wherein the operations are any two of the following:
the standard “must contain” operation;
the standard “must not contain” operation (the logical or boolean NOT);
the standard full-text “may contain” operation (indicating priority).

10. The SES recited in claim 4 wherein:
the label for the “must contain” operation is “FIND,” “INCLUDE,” “MATCH,” “LOCATE” or similar word or phrase, in English or other language;
the label for the “must not contain” operation is “OMIT,” “EXCLUDE,” “NOT,” “EXCEPT” or similar word or phrase, in English or other language;
the label for the “may contain” operation is “PREFER,” “DESIRABLE,” “GIVE PREFERENCE TO” or similar word or phrase, in English or other language.

11. The SES recited in claim 1 wherein the SES displays entry fields on a fill-in form employing a markup language such as HTML, XML or SGML.

12. The SES recited in claim 1 wherein the SES displays entry fields on a fill-in form employing a portable document technology.

13. The SES recited in claim 1 wherein the SES is implemented as a desktop, client-server, and/or n-tier application.

14. The SES recited in claim 1 wherein the ILM is comprised of multiple ILMs whose syntax may vary from one to another, and wherein the translator is configured to translate to the predetermined syntax for each ILM.

15. The SES recited in claim 1 wherein the translator invokes the ILM in a procedural, object-oriented and/or other programmatic fashion.

16. The SES recited in claim 1 further comprising an option entry field configured to receive one of a plurality of displayed options, wherein the translator is further configured to translate the first search input and the second search input into the valid ILM syntax that corresponds to the received option.

17. The SES recited in claim 16 wherein the options are at least two of the following, or similar word or phrase, in English or other language:
“Every Word;”
“Any Word;”
“Phrase;”
“Every Word or Quoted Phrase;”
“Any Word or Quoted Phrase;”
“Boolean Expression.”

18. The SES recited in claim 1 further comprising a plurality of option entry fields configured to receive input, wherein the translator is further configured to translate the first search input and the second search input into the valid ILM syntax that corresponds to the received options.

19. The SES recited in claim 18 wherein the options are at least one of the following, or similar: “WHOLE WORD,” “CASE SENSITIVE,” “MIXED CASE IS CASE SENSITIVE,” “STEMMING,” “WILDCARD AT END,” “WILDCARD AT START.”

20. The SES recited in claim 1 further comprising a third entry field configured to receive a third search input from the UD, the third entry field having a fixed association with the data element and with a third search operation, and wherein the translator is further configured to translate the third search input and the third search operation into a syntax that is valid for the ILM.

21. The SES recited in claim 1 wherein the data element is part of a data object, the data object having at least one data unit of employment information.

22. The SES recited in claim 1 further comprising at least one additional pair of entry fields, wherein each entry field within each pair has a fixed association with a different search operation than the other entry field in the pair, and wherein each pair has a fixed association with the same data element, and wherein the translator is configured to translate the additional plurality of search inputs, data element identifiers and search operations into a syntax that is valid for the ILM.

23. A search system comprising:
an SES as recited in claim 1;
an ILM coupled to a data repository containing a plurality of data objects, the ILM being configured to receive the search criteria in a predetermined syntax, search the data repository, and retrieve zero or more data objects that conform to the search criteria;
a formatting engine to format the results from the ILM; and
a client process and VDU to display the formatted results.

24. The search system recited in claim 23 wherein the SES displays entry fields on a fill-in form employing a markup language such as HTML, XML or SGML.

25. The search system recited in claim 23 wherein the contents of at least one data element of at least one data object include employment information.

26. The search system recited in claim 23, further including:
a sort port to receive sort criteria;
an Information Sorting Mechanism (ISM) coupled between the ILM and the formatting engine; the ISM being configured to receive the sort criteria in a predetermined syntax, receive a plurality of data objects from the ILM, sort the data objects according to the sort criteria, and forward the sorted data objects to the formatting engine.

27. A search entry method for aiding a user in employing an Information Location Mechanism (ILM) to locate relevant information, the method comprising:
providing a first entry field for receiving a first search input from the UD, the first entry field having a fixed association with a data element and with a first search operation;
providing a second entry field for receiving a second search input from the UD, the second entry field having a fixed association with the data element and with a second search operation;
translating the first search input, the second search input, the data element's identifier, the first search operation, and the second search operation into a syntax that is valid for the ILM; and
sending the translated search criteria to the ILM and/or to the mechanism that invoked the search entry method;
whereby users can easily provide search criteria without knowing the syntax of the ILM or understanding how to construct a boolean search and whereby novice users are made aware of search operations that will help them find their desired result.
